(19) United States
(12) Patent Application Publication
(10) Pub. No.: US 2024/0059030 A1
(43) Pub. Date: Feb. 22, 2024

(54) MANUFACTURING CELL, MANUFACTURING SYSTEM AND METHOD

(71) Applicant: University of Strathclyde, Glasgow (BG)

(72) Inventors: Iain BOMPHRAY, Renfrew (GB); Alexander COCHRANE, Renfrew (GB); Catherine YOKAN, Renfrew (GB); David FYVIE, Renfrew (GB); Ruoyu HUANG, Renfrew (GB); Tobias WEIS, Renfrew (GB)

(21) Appl. No.: 18/038,944

(22) PCT Filed: Nov. 26, 2021
(86) PCT No.: PCT/GB2021/053097

§ 371 Date: May 25, 2023

(30) Foreign Application Priority Data
Nov. 27, 2020 (GB) 2018765.4

(51) Int. Cl. B29C 70/38

(52) U.S. Cl. CPC B29C 70/384

(57) ABSTRACT

A reconfigurable manufacturing cell (10) for use in a manufacturing system (100; 200), e.g. pilot line, comprises a plinth (12) and a table (14) disposed on top of the plinth (12). The plinth (12) is modular in construction having a plurality of plates (26a-26k) and/or blocks. In particular but not exclusively, the cell (10) further comprises a collaborative robot (16) and an industrial robot (18), the industrial robot (18) configured to receive a variety of different end effectors such as an end effector (22) configured to perform an automated fibre placement (AFP) operation.

### FIELD

This relates to a manufacturing cell, to a manufacturing system, e.g. pilot line, comprising one or more of said manufacturing cells and to a manufacturing method utilising said manufacturing cell.

### BACKGROUND

Pilot lines are small pre-production lines and are conventionally fixed in place, with fixed footprint, fixed capability, and high setup cost.

### SUMMARY

Aspects of the present disclosure relate to a manufacturing cell, to a manufacturing system, e.g. line, comprising one or more of said manufacturing cells and to a manufacturing method utilising said manufacturing cell or cells.

According to a first aspect, there is provided a manufacturing cell. The manufacturing cell may be reconfigurable. For example, the manufacturing cell may be configurable in a plurality of different configurations.

Beneficially, the manufacturing cell and thus the system (e.g. pilot line) comprising the cells, may be reconfigurable, such that the capabilities of the cells making up the production processes can be readily changed out to change the system's capability offering. The manufacturing cell is particularly beneficial for facilitating processes such as those used in the construction of composites, including automated fibre placement (“AFP”), dry fibre layup, e.g. Staxx, RTM, machining and the like. The cells would host a given capability at any time but are highly versatile, with the ability to change out manufacturing capability as well as supporting infrastructure like robotics and digital elements. The cell can act as a smart workbench and an automated production cell depending on demand.

Moreover, the manufacturing cell and systems constructed using one or more of the cells, provide significant flexibility; particularly useful in highly variable manufacturing processes, where supply chains are fragmented and/or where a resilient and agile supply chain is required to respond to demand.

The manufacturing cell may comprise a plinth. The plinth may form the foundation of the manufacturing cell.

The plinth may be modular and/or reconfigurable in construction.

The plinth may comprise a plurality of plates.

One or more of the plates may be constructed from a metal or metallic material. In particular embodiments, the plates may be constructed from Aluminium. However, it will be recognised that the plates may be constructed from any suitable material. For example, one or more of the plates may be constructed from one or more of: a metal or metal alloy; a wooden material; a polymeric material; a composite material, such as a fibre-reinforced material (e.g. glass-fibre reinforced material or carbon-fibre reinforced material; a ceramic material.

The plates may take a number of different configurations.

At least two of the plates may be of the same or substantially the same configuration, e.g. the same length, the same height, the same thickness, and/or the same shape. In some embodiments, all of the plates are of the same or substantially the same configuration.

Alternatively or additionally, at least one of the plates may be of a different configuration, e.g. a different length, a different height, a different thickness, and/or a different shape to at least one other of the plates.

The plinth may comprise a plurality of blocks.

One or more of the blocks may be constructed from a metal or metallic material. In particular embodiments, the blocks may be constructed from Aluminium. However, it will be recognised that the blocks may be constructed from any suitable material. For example, one or more of the blocks may be constructed from one or more of: a metal or metal alloy; a wooden material; a polymeric material; a composite material, such as a fibre-reinforced material (e.g. glass-fibre reinforced material or carbon-fibre reinforced material); and a ceramic material.

The blocks may take a number of different configurations.

At least two of the blocks may be of the same or substantially the same configuration, e.g. the same length, the same height, the same thickness, and/or the same shape. In some embodiments, all of the blocks are of the same or substantially the same configuration.

Alternatively or additionally, at least one of the blocks may be of a different configuration, e.g. a different length, a different height, a different thickness, and/or a different shape, to at least one other of the blocks.

The plates and/or blocks may be coupled together by a coupling arrangement.

For example, the plates and/or blocks may be coupled together by fasteners. In particular embodiments, the fasteners may take the form of cap screws. The fasteners may engage bores in the plates and/or blocks.

However, it will be recognised that the fasteners may take the form of any suitable coupling arrangement. For example, at least one of the plates and/or blocks may comprise or define a male profile configured to engage a female profile in another of the plates and/or blocks. Alternatively or additionally, at least one of the plates and/or blocks may comprise or define a female profile configured to engage a male profile in another of the plates and/or blocks.

The plinth may define one or more channels. The channels may run throughout the structure internally and are intended to allow for routing of services e.g. one or more of: electrics; data; hydraulics; pneumatics; water/air, and the like.

The plinth may take any suitable size or shape.

The plinth may be rectangular in shape. The plinth may be square in shape. The plinth may have a width in the range of 1 metre or approximately 1 metre to 2 metres or approximately 2 metres. The plinth may have a width of 1 metre or approximately 1 metre. The plinth may have a width of 2 metres or approximately 2 metres. The plinth may have a breadth in the range of 1 metre or approximately 1 metre to 2 metres or approximately 2 metres. The plinth may have a breadth of 1 metre or approximately 1 metre. The plinth may have a breadth of 2 metres or approximately 2 metres.

The manufacturing cell may comprise feet. The plinth may be supported on the ground or other support surface by the feet. However, it will be recognised that the plinth may alternatively be disposed directly on the ground or floor surface.

The manufacturing cell may comprise a table. The table may be disposed on the top of the plinth. In particular embodiments, the table may take the form of a T-slotted table having a number of slots. The table may be secured to the plinth. The table may be secured to the plinth by a coupling arrangement. The coupling arrangement may comprise fasteners. In particular embodiments, the fasteners may take the form of bolts. However, it will be recognised that the fasteners may take the form of any suitable coupling arrangement. The fasteners may engage corresponding bores in the plinth.

Beneficially, the provision of a T-slotted table facilitates easy installation and/or removal of a manufacturing capability.

The manufacturing cell may comprise one or more robotic devices.

The manufacturing cell may comprise a collaborative robot “cobot”. The cobot is mounted to the plinth. The cobot may be supported on ballast disposed within the plinth.

The manufacturing cell may comprise an industrial robot.

At least one of the one or more robotic devices may comprise or take the form of a robotic arm.

The cobot may comprise or take the form of a robotic arm. The cobot may be configured or arranged to provides pick-and-place capability and/or to facilitate co-working with a user. In particular embodiments, the cobot may comprise or takes the form of a UR10e from Universal Robots. However, it will be understood that the manufacturing cell may comprise any suitable form of cobot.

The industrial robot may comprise or take the form of a robot arm. In particular embodiments, the industrial robot may comprise or take the form of a KR20-1810 from KUKA. However, it will be understood that the manufacturing cell may comprise any suitable form of industrial robot.

The industrial robot may be configured to receive a variety of different end effectors. For example, but not exclusively, the industrial robot may comprise an end effector in the form of an automated fibre placement (“AFP”) end effector, such that the industrial robot may be configured to perform an automated fibre placement (“AFP”) operation such as used in the construction of laminated composite components.

The industrial robot may be mounted on a base. The base may be disposed alongside the plinth. However, the industrial robot may alternatively be coupled to or form part of the plinth, such that the industrial robot may be grounded through the plinth.

The manufacturing cell may be configured for coupling to one or more services, such as one or more of: electrics; data; hydraulics; pneumatics; water/air, and the like.

The manufacturing cell may comprise a monoblock connector. The monoblock may be disposed within the plinth. However, the monoblock connector may alternatively be disposed outside of the plinth. The monoblock connector may facilitate coupling of the manufacturing cell to the services, such as the one or more of: electrics; data; hydraulics; pneumatics; water/air, and the like described above.

The manufacturing cell, or any individual component or groups of components thereof, may be manufactured in any suitable manner. In some examples the disclosed manufacturing cell, or any individual component or groups of components thereof, may be manufactured by additive manufacturing. Such described additive manufacturing typically involves processes in which components are fabricated based on three-dimensional (3D) information, for example a three-dimensional computer model (or design file), of the component.

Accordingly, examples described herein not only include the manufacturing cell and associated components, but also methods of manufacturing the manufacturing cell or associated components via additive manufacturing and computer software, firmware or hardware for controlling the manufacture of the manufacturing cell and associated components via additive manufacturing. All future reference to “product” are understood to include the described manufacturing cell and all associated components.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files may take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files may be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. The formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that may be used to physically generate the object, upon execution of the code or instructions by an additive manufacturing system. For example, the instructions may include a precisely defined 3D model of the product and may be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus may be instructed to print out the product.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself may automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Given the above, the design and manufacture of implementations of the subject matter may be realised using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this disclosure may be realised using one or more computer programs, i.e., one or more modules of computer program instructions, encoded on computer storage medium for execution by, or to control the operation of, a data processing apparatus. Alternatively or in addition, the program instructions may be encoded on an artificially generated propagated signal, e.g., a machine-generated electrical, optical, or electromagnetic signal that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique, or other manufacturing technology for example casting, machining, laser cutting, drilling, rolling, or the like.

According to a second aspect, there is provided a manufacturing system comprising one or more of the manufacturing cells according to the first aspect.

The system may comprise or take the form of a manufacturing line, in particular but not exclusively a pilot line.

The system may comprise or take the form a cellular manufacturing system.

The system may comprise one of the cells according to the first aspect.

Alternatively, the system may comprise a plurality of the cells according to the first aspect.

The system may further comprise one or more of: a cleanroom; a metrology station; a machining tool, a PEI press, an autoclave and an RTM press.

Where the system comprises a plurality of the cells, the cells may be arranged in a network. The cells may be arranged in a line.

The system may comprise an automated vehicle for transporting components between cells and/or other parts of the system.

According to a third aspect, there is provided a manufacturing method using one or more of the manufacturing cells according to the first aspect or the manufacturing system according to the second aspect.

The invention is defined by the appended claims. However, for the purposes of the present disclosure it will be understood that any of the features defined above or described below may be utilised in isolation or in combination. For example, features described above in relation to one of the above aspects or below in relation to the detailed description below may be utilised in any other aspect, or together form a new aspect.

### BRIEF DESCRIPTION OF THE DRAWINGS

These and other aspects or examples will now be described, by way of example only, with reference to the accompanying drawings, in which:

FIG. 1 shows a perspective view of a manufacturing cell for use in a manufacturing system;

FIG. 2 shows an elevation view of the manufacturing cell shown in FIG. 1;

FIG. 3 shows a partially ghosted perspective view of the manufacturing cell shown in FIG. 1;

FIG. 4 shows an end effector of an industrial robot of the manufacturing cell shown in FIG. 1;

FIG. 5 is a perspective view of the plinth of the manufacturing cell shown in FIG. 1, in isolation;

FIG. 6 is an exploded view of the plinth of the manufacturing cell shown in FIG. 1, in isolation;

FIGS. 7 and 8 show a monoblock connector of the manufacturing cell shown in FIG. 1;

FIGS. 9 and 10 show perspective views of the plinth and table of the manufacturing cell shown in FIG. 1, in isolation perspective views the plinth and table of the manufacturing cell shown in FIG. 1, in isolation;

FIG. 11 shows a manufacturing system comprising the manufacturing cell shown in FIG. 1;

FIG. 12 an alternative manufacturing system comprising a plurality of the manufacturing cells shown in FIG. 1;

FIG. 13 shows part of the manufacturing system shown in FIG. 12;

FIG. 14 shows an automated vehicle for use in one or both of the systems shown in FIGS. 11 and 12;

FIG. 15 shows an alternative plinth for use in a manufacturing system;

FIGS. 16 and 17 show an alternative manufacturing cell;

FIG. 18 shows an alternative plinth of a manufacturing cell;

FIGS. 19 to 23 show enlarged perspective views of blocks of the plinth shown in FIG. 18;

FIG. 24 shows an alternative plinth of a manufacturing cell;

FIGS. 25, 26 and 27 show an alternative manufacturing cell;

FIGS. 28, 29 and 30 show plates of the manufacturing cell shown in FIG. 25;

FIGS. 31 and 32 shows fasteners of the manufacturing cell shown in FIG. 25;

FIGS. 33 to 37 show enlarged perspective views of blocks of the plinth of the manufacturing cell shown in FIG. 25;

FIG. 38 shows an alternative manufacturing cell;

FIG. 39 shows an alternative manufacturing cell;

FIG. 40 shows an alternative manufacturing cell;

FIG. 41 shows an alternative manufacturing cell; and

FIG. 42 shows an alternative manufacturing system.

### DETAILED DESCRIPTION

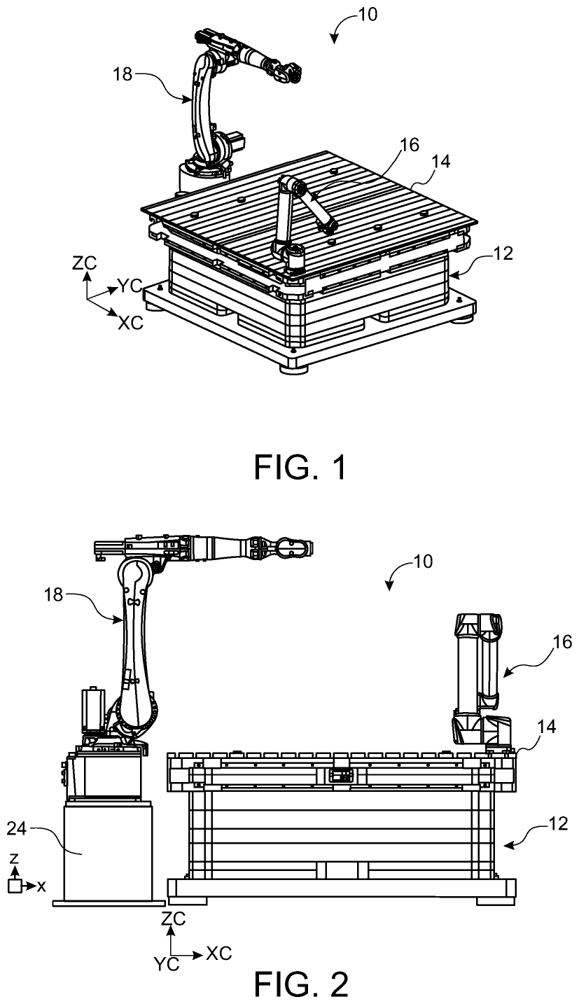

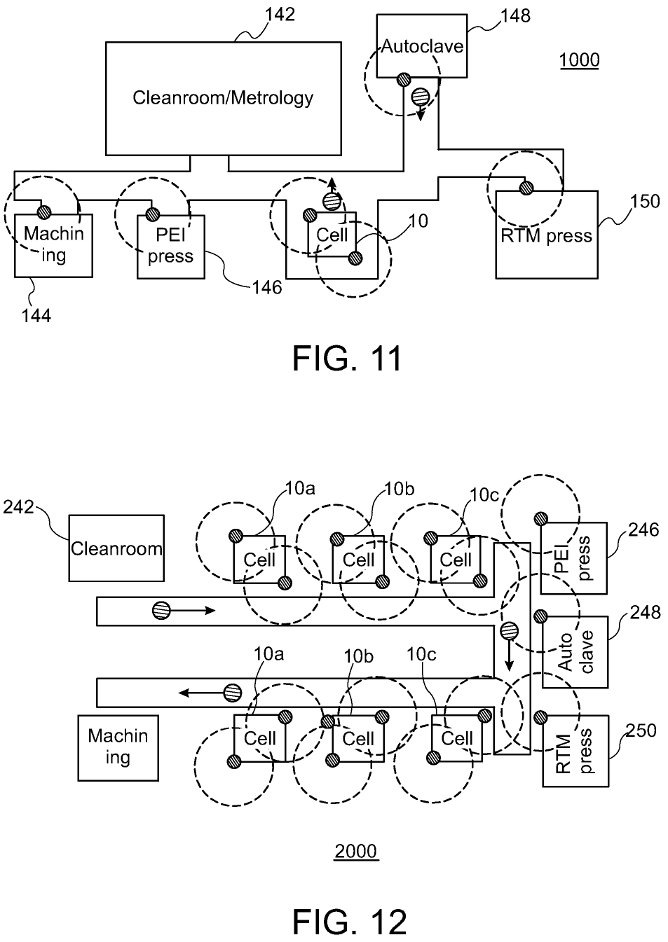

Referring first to FIGS. 1 to 3 of the accompanying drawings, there is shown a manufacturing cell 10 for use in a manufacturing system (examples of which are shown and described below with reference to FIGS. 11 to 14).

As shown in FIGS. 1, 2 and 3, the manufacturing cell 10 comprises a plinth 12, a table 14, a collaborative robot (“cobot”) 16 and an industrial robot 18. The plinth forms the foundation of the cell 10.

The cobot 16 takes the form of a robot arm and provides pick-and-place capability and facilitates co-working with a user. In the illustrated manufacturing cell 10, the cobot 16 comprises or takes the form of a UR10e from Universal Robots. However, it will be understood that the manufacturing cell 10 may comprise any suitable form of cobot.

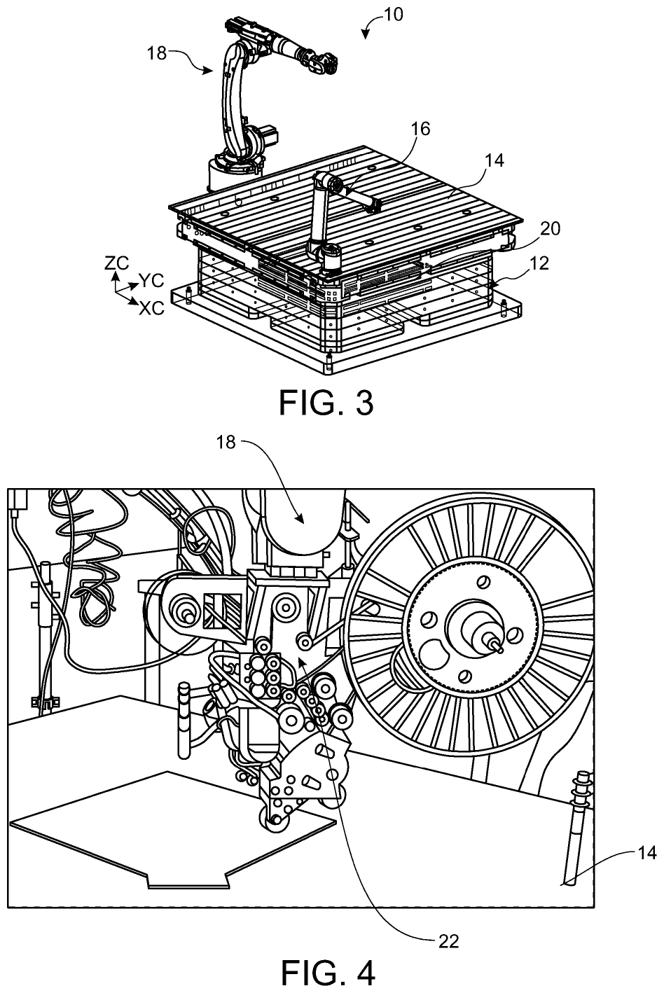

As shown in FIG. 3 of the accompanying drawings, the cobot 16 is mounted to the plinth 12. The cobot 16 is supported on ballast 20 disposed within the plinth 12.

The industrial robot 18 takes the form of a robot arm. In the illustrated manufacturing cell 10, the industrial robot 18 comprises or takes the form of a KR20-1810 from KUKA. However, it will be understood that the manufacturing cell 10 may comprise any suitable form of industrial robot.

The industrial robot 18 may be configured to receive a variety of different end effectors. In the illustrated cell 10, and as shown in FIG. 4 of the accompanying drawings, the industrial robot 18 comprises an end effector 22 in the form of an automated fibre placement (“AFP”) end effector, such that the industrial robot 18 is configured to perform an automated fibre placement (“AFP”) operation such as used in the construction of laminated composite components.

In the illustrated cell 10, the industrial robot 18 is mounted on a base 24 which is disposed alongside the plinth 12. However, the industrial robot 18 may alternatively be coupled to or form part of the plinth 12, such that the industrial robot 18 is grounded through the plinth 12.

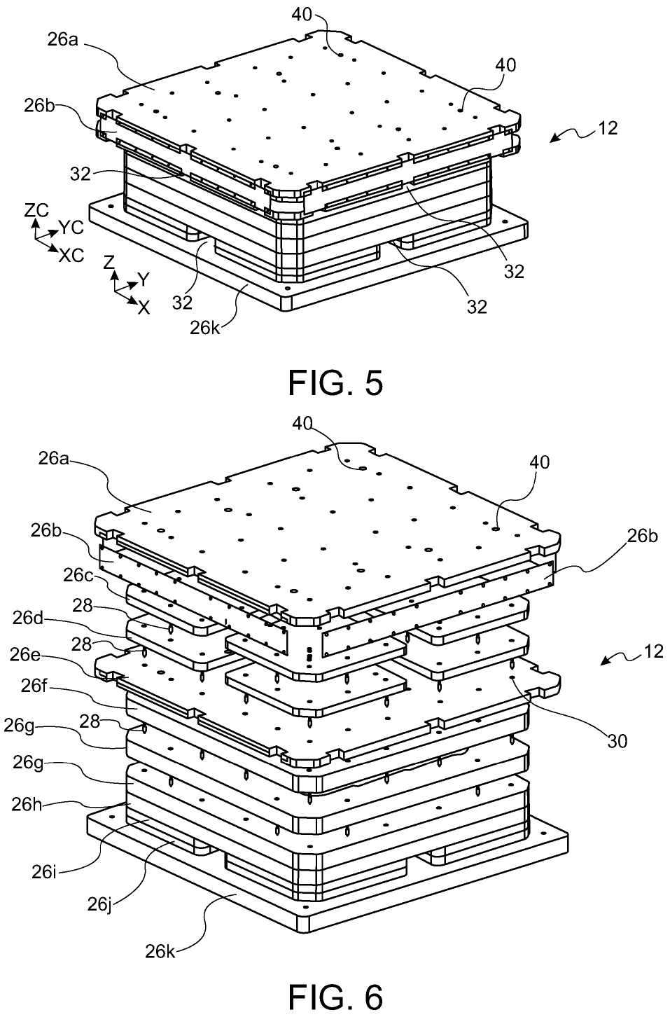

FIGS. 5 and 6 of the accompanying drawings show perspective views of the plinth 12, in isolation. As shown most clearly in FIG. 6, which shows an exploded perspective view, the plinth 12 is modular and/or reconfigurable in construction and comprises a number of plates, 26a, 26b, 26c, 26d, 26e, 26f, 26g, 26h, 26i, 26j, 26k.

In the illustrated plinth 12, the plates 26a-26k are constructed from Aluminium. However, it will be recognised that the plates 26a-26k may be constructed from any suitable material. For example, one or more of the plates may be constructed from one or more of: a metal or metal alloy; a wooden material; a polymeric material; a composite material, such as a fibre-reinforced material (e.g. glass-fibre reinforced material or carbon-fibre reinforced material; a ceramic material.

In the illustrated manufacturing cell 10, the plinth 12 is, or is approximately, 2 metres wide and long and is, or is approximately, 0.85 metres in height. However, it will be recognised that the plinth 12 may take any suitable size or shape.

As can be seen, the plates 26a-26k take a number of different configurations.

Plate 26a forms a top plate of the plinth 12 for supporting the table 14. Plate 26e forms an intermediate plate of the plinth 12. Plate 26k forms a base of the plinth 12. Plates 26b define removable face plates to facilitate access to the space underneath the plate 26a forming the top plate, e.g. to access services, cabling and the like.

The plates 26a-26k are coupled together by a fasteners 28. In the illustrated plinth 12, the fasteners 28 take the form of cap screws which engage bores 30 in the plates 26a-26k. However, it will be recognised that the fasteners may take the form of any suitable coupling arrangement. For clarity, only a few of the fasteners 28 and bores are shown.

In the illustrated manufacturing cell 10, the cell 10 comprises feet 31. The plinth is supported on the ground or other support surface by the feet 31. However, it will be recognised that the plinth 10 may alternatively be disposed directly on the ground or floor surface.

As can be seen for example in FIG. 5, when assembled the plinth 12 defines a number of channels 32. The channels 32 run throughout the structure internally and are intended to allow for routing of services e.g. one or more of: electrics; data; hydraulics; pneumatics; water/air, and the like.

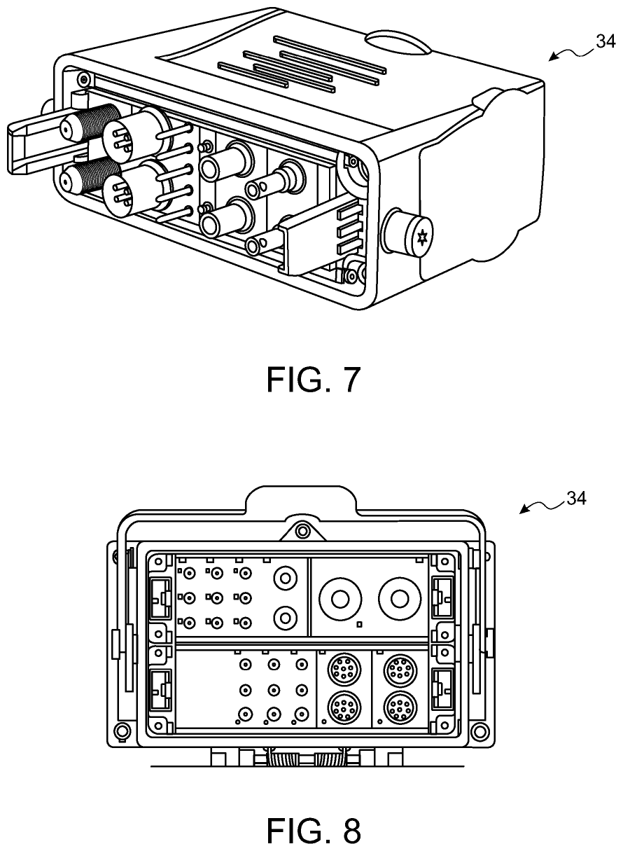

FIGS. 7 and 8 show a monoblock connector 34. In the illustrated manufacturing cell 10, the monoblock 34 is disposed within the plinth 12. However, the monoblock connector 34 may alternatively be disposed outside of the plinth 12. The monoblock connector 34 facilitates coupling of the manufacturing cell 10 to the services, such as the one or more of: electrics; data; hydraulics; pneumatics; water/air, and the like described above.

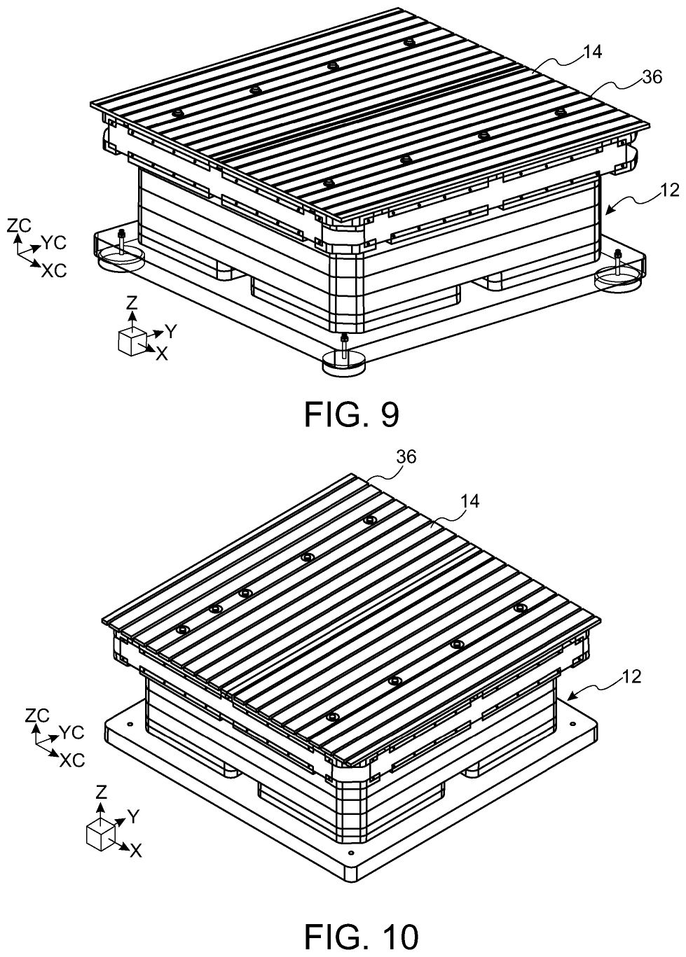

As described above, and referring now also to FIGS. 9 and 10 of the accompanying drawings, the manufacturing cell 10 comprises a table 14. As shown in FIGS. 9 and 10, the table 14 is disposed on the top of the plinth 12. In the illustrated manufacturing cell 10, the table 14 takes the form of a T-slotted table having a number of slots 36. The table 14 is secured to the plinth 12, in particular the plate 26a, by fasteners 38. In the illustrated cell 10, the fasteners 38 take the form of bolts. However, it will be recognised that the fasteners may take the form of any suitable coupling arrangement. The fasteners 38 engage corresponding bores 40 (shown in FIGS. 5 and 6) in the plate 26a.

Beneficially, the provision of a T-slotted table facilitates easy installation and/or removal of a manufacturing capability.

The manufacturing cell 10 provides a number of significant benefits over conventional equipment.

FIG. 11 of the accompanying drawings show a diagrammatic view of a manufacturing system 1000 comprising the manufacturing cell 10 described above. The manufacturing system 1000 takes the form of a cellular manufacturing system for manufacturing composites. The illustrated system 1000 comprises one manufacturing cell 10, a cleanroom/metrology station 142, a machining tool 144, a PEI press 146, an autoclave 148 and an RTM press 150.

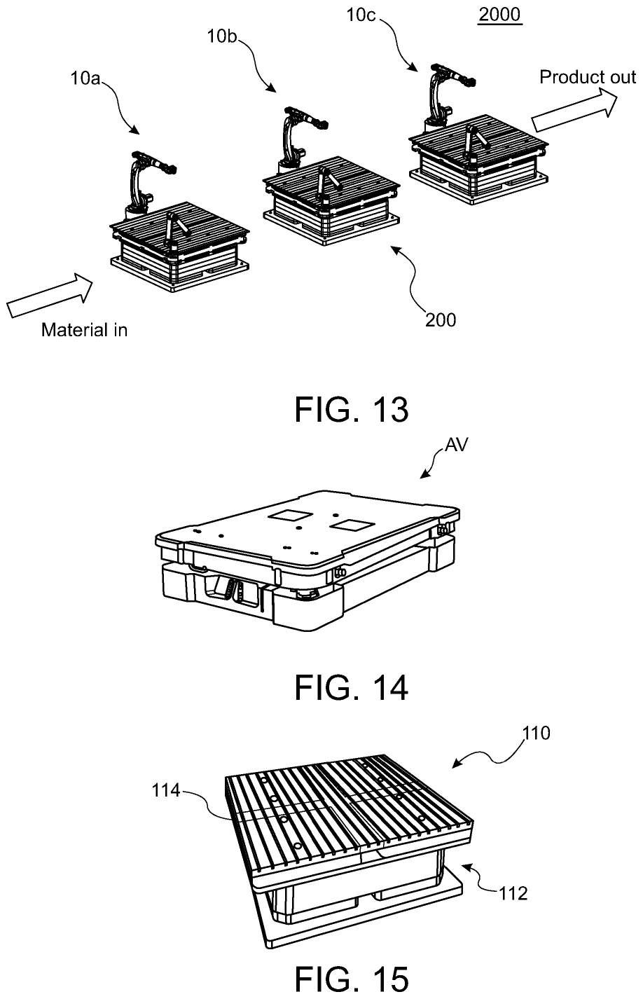

FIGS. 12 and 13 of the accompanying drawings show an alternative manufacturing system 2000, which comprises a plurality of the cells 10. As shown in FIGS. 12 and 13, the manufacturing system 2000 takes the form of a cellular manufacturing system for manufacturing composites. As shown in FIG. 12, which shows a diagrammatic view of the system 2000, the system 2000 comprises six of the manufacturing cells 10, a cleanroom/metrology station 242, a machining tool 244, a PEI press 246, an autoclave 248, and an RTM press 150.

In the manufacturing system 2000, the cells 10 are arranged in a network of multiple cells 10, with each cell 10 configured to perform a particular task. As shown in FIG. 13, a first cell, denoted here as 10a, may be configured to perform a kit-cutting process, a second cell, denoted here as 10b, may be configured to perform a laminating process, and a third cell, denoted here as 10c, may be configured to perform a preforming process.

In either or both of the systems 1000, 2000 components may be moved between cells 10 by a user or by an automated vehicle AV such as shown in FIG. 14 of the accompanying drawings.

It will be understood that various modifications may be made without departing from the scope of the claimed invention.

For example, while in the manufacturing cell 10 described above the plinth 12 is constructed from machined Aluminium, FIG. 15 shows an alternative manufacturing cell 110 comprising a plinth 112 and table 114 which are constructed using 3-d printing.

As described above, the manufacturing cells and systems are reconfigurable, such that the capabilities of the cells making up the production processes can be readily changed out to change the system's capability offering. The manufacturing cell is particularly beneficial for facilitating processes such as those used in the construction of composites, including automated fibre placement (“AFP”), dry fibre layup, e.g. Staxx, RTM, machining and the like. The cells would host a given capability at any time but are highly versatile, with the ability to change out manufacturing capability as well as supporting infrastructure like robotics and digital elements. The cell can act as a smart workbench and an automated production cell depending on demand.

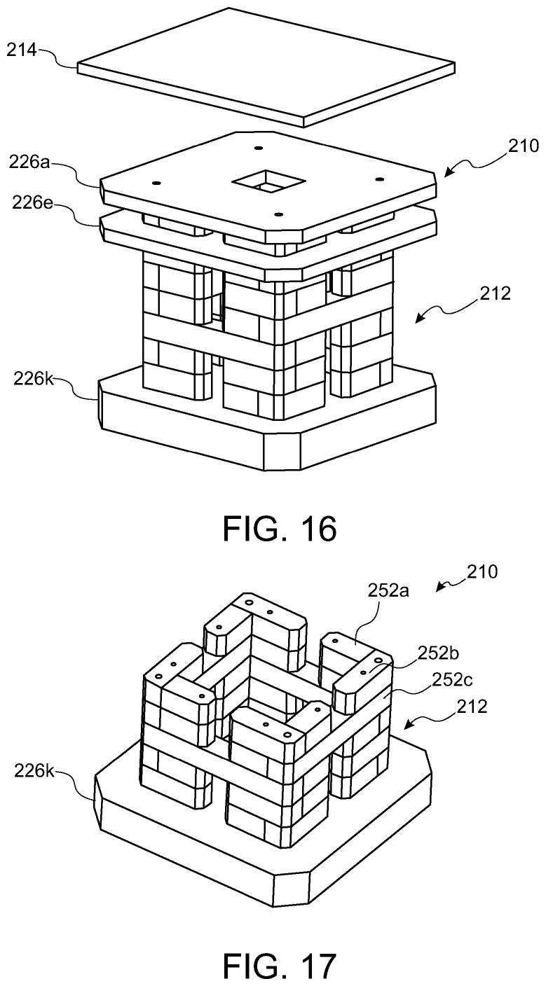

For example, FIGS. 16 and 17 of the accompanying drawings show an alternative manufacturing cell 210. As shown, the manufacturing cell 210 comprises a plinth 212 and a table 214.

The plinth 212 is modular and/or reconfigurable in construction and comprises a number of plates 226a, 226e, 226k and blocks 252a, 252b, 252c.

Plate 226a forms a top plate of the plinth 212 for supporting the table 214. Plate 226e forms an intermediate plate of the plinth 212. Plate 226k forms a base of the plinth 212.

As shown most clearly in FIG. 17, the plinth 212 is constructed from a plurality of each of the blocks 252a, 252b, 252c.

Beneficially, this means that the plinth 212 can be constructed from a relatively few number of part types, e.g. reducing manufacturing complexity and/or permitting the plinth 212 to be readily reconfigured as required according to the desired application.

In the illustrated plinth 212, the plates 226a, 226e, 226k and the blocks 252a, 252b, 252c are constructed from Aluminium. However, it will be recognised that the plates 226a, 226e, 226k and the blocks 252a, 252b, 252c may be constructed from any suitable material. For example, one or more of the plates 226a, 226e, 226k and the blocks 252a, 252b, 252c may be constructed from one or more of: a metal or metal alloy; a wooden material; a polymeric material; a composite material, such as a fibre-reinforced material (e.g. glass-fibre reinforced material or carbon-fibre reinforced material; a ceramic material.

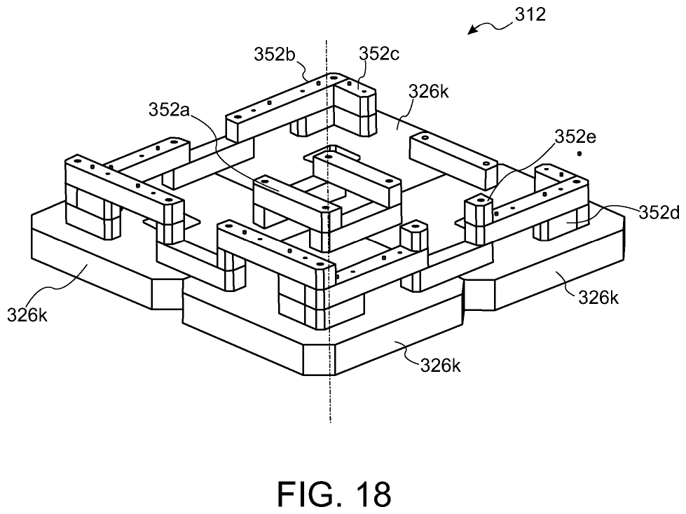

FIG. 18 of the accompanying drawings shows a further alternative plinth 312.

As shown in FIG. 18, the plinth 312 is modular and/or reconfigurable in construction and comprises a plurality of plates 326k, which together form a base of the plinth 312, and a plurality of blocks 352a, 352b, 352c, 352d, 352e.

As shown in FIG. 18, the plinth 312 is constructed from a plurality of each of the blocks 352a, 352b, 352c, 352d, 352e.

Beneficially, this means that the plinth 312 can be constructed from a relatively few number of part types and/or permits the plinth 312 to be readily reconfigured in terms of its size and/or shape as required.

In the illustrated plinth 312, the plates 326k and the blocks 352a, 352b, 352c, 352d, 352e are constructed from Aluminium. However, it will be recognised that the plates 326k and the blocks 352a, 352b, 352c, 352d, 352e may be constructed from any suitable material. For example, one or more of the plates 326k and the blocks 352a, 352b, 352c, 352d, 352e may be constructed from one or more of: a metal or metal alloy; a wooden material; a polymeric material; a composite material, such as a fibre-reinforced material (e.g. glass-fibre reinforced material or carbon-fibre reinforced material; a ceramic material.

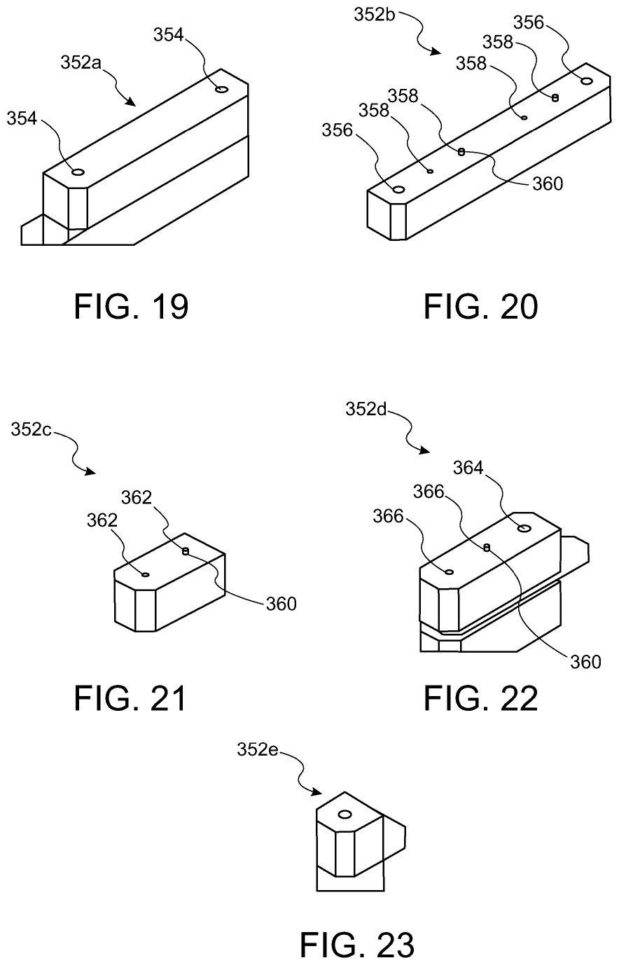

FIG. 19 shows an enlarged perspective view of one of the blocks 352a. As shown, the block 352a is generally cuboidal in shape, having chamfered edges at two of its corners. The block 352a further comprises two bores 354 for receiving fasteners to facilitate coupling of the block 352a to one or more other blocks selected from the blocks 352a, 352b, 352c, 352d, 352e.

FIG. 20 shows an enlarged perspective view of block 352b. As shown, the block 352b is generally cuboidal in shape, having chamfered edges at two of its corners. The block 352b has the same width and height as the block 352a but has a greater length than the block 352a. The block 352b further comprises two bores 356 for receiving fasteners and four bores 358, two of which are shown having dowels 360 received therein. The bores 356 have a larger diameter than the bores 358.

FIG. 21 shows an enlarged perspective view of block 352c. As shown, the block 352c is generally cuboidal in shape, having chamfered edges at two of its corners. The block 352c has the same width and height as the block 352a but has a shorter length than the block 352a. The block 352c further comprises two bores 362, of which one is shown having a dowel 360 received therein. The bores 362 have the same diameter as the bores 358, permitting the same dowels 360 to be used.

FIG. 22 shows an enlarged perspective view of block 352d. As shown, the block 352d is generally cuboidal in shape, having chamfered edges at three of its corners. The block 352d has the same width and height as the block 352a, a shorter length than the block 352a and a longer length than the block 352c. The block 352d further comprises a bore 364 for receiving a fastener and two bores 366, one of which is shown having a dowel 360 received therein. The bores 366 have the same diameter as the bores 358, permitting the same dowels 360 to be used.

FIG. 23 shows an enlarged perspective view of block 352e. As shown, the block 352e is generally cuboidal in shape, having chamfered edges at two of its corners. The block 352e has the same width and height as the block 352a but a shorter length than the block 352c. The block 352e further comprises a bore 368 having a dowel 360 received therein. The bores 368 has the same diameter as the bores 358, permitting the same dowels 360 to be used.

While the illustrated blocks 352a, 352b, 352c, 352d, 352d, 352e comprise bores 354, 358, 362, 366 and dowels 360, it will be recognised that the blocks 352a, 352b, 352c, 352d, 352d, 352e may alternatively or additionally comprise one or more male and/or females portions to facilitate coupling of the blocks 352a, 352b, 352c, 352d, 352d, 352e to each other and/or to the plates 326k.

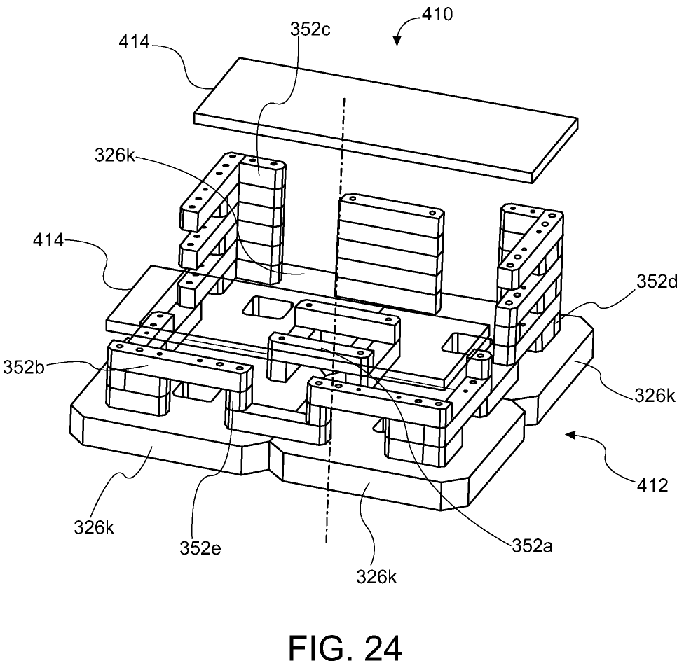

FIG. 24 of the accompanying drawings shows an alternative manufacturing cell 410, utilising an alternative construction of the plates 326k and the blocks 352a, 352b, 352c, 352d, 352e.

As shown in FIG. 24, the manufacturing cell 410 comprises a plinth 412 for supporting two tables 414.

The plinth 412 is modular and/or reconfigurable in construction and comprises a plurality of the plates 326k, which together form a base of the plinth 412, and a plurality of the blocks 352a, 352b, 352c, 352d, 352e.

Beneficially, this means that the plinth 412 can be constructed from a relatively few number of part types, e.g. reducing manufacturing complexity and/or permitting the plinth 212 to be readily reconfigured as required according to the desired application.

FIG. 24 illustrates that the adaptability of the construction, the manufacturing cell 410 facilitating the use of two tables 414 at differing heights.

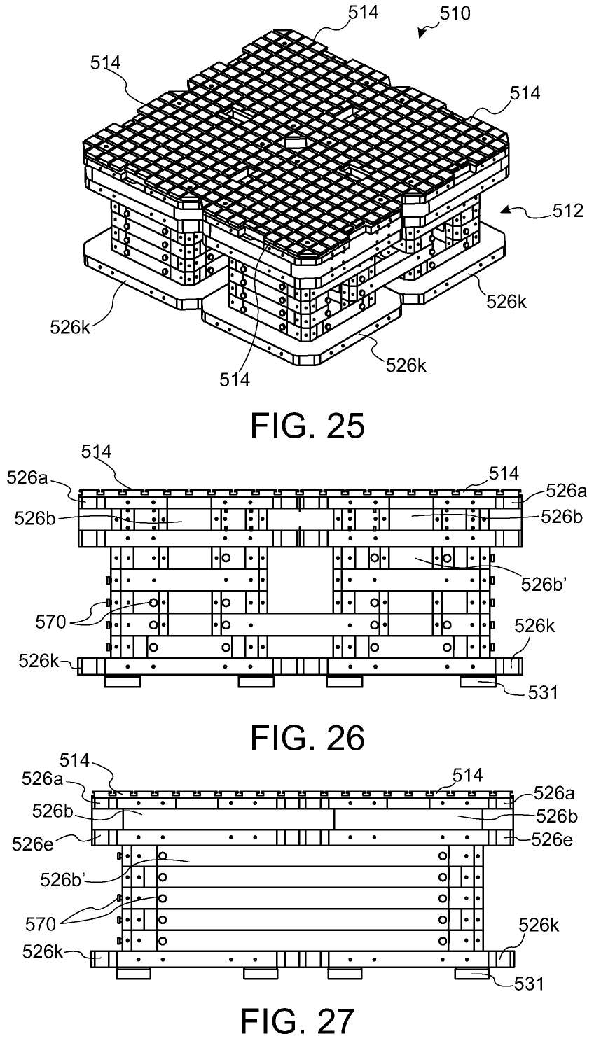

FIGS. 25 to 27 of the accompanying drawings shows an alternative manufacturing cell 510.

As shown, the manufacturing cell 510 comprises a plinth 512 and four tables 514, which together form an upper surface of the cell 510.

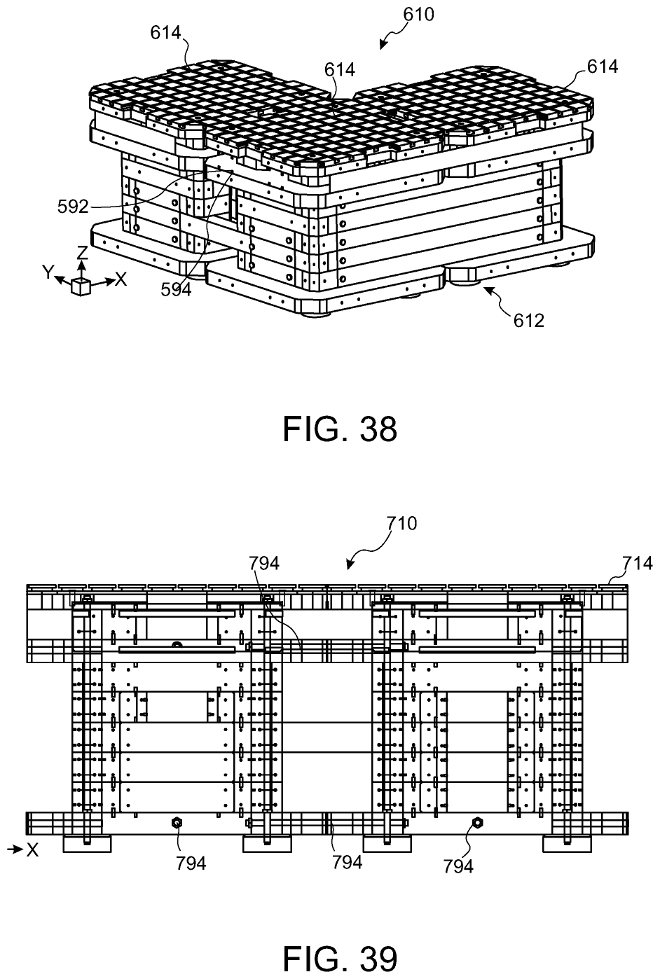

The plinth 512 is modular and/or reconfigurable in construction. Plates 526a form a top plate of the plinth 512 for supporting the tables 514. Plates 526b define removable face plates to facilitate access to the space underneath the plates 526a forming the top plate, e.g. to access services, cabling and the like. The plates 526b are secured using magnets (592, shown in FIG. 38). Plates 526b′ define additional face plates to facilitate access to the interior of the plinth 512. The plates 526b′ are secured by screws 570. Plates 526e form an intermediate plate of the plinth 512. Plates 526k together form a base of the plinth 512.

As shown, the plinth 512 is constructed from a plurality of each of the blocks 552a, 552b, 552c, 552d, 552e.

Beneficially, this means that the plinth 512 can be constructed from a relatively few number of part types, e.g. reducing manufacturing complexity and/or permitting the plinth 512 to be readily reconfigured as required according to the desired application.

In the illustrated manufacturing cell 510, the cell 510 comprises feet 531. The plinth 510 is supported on the ground or other support surface by the feet 531. However, it will be recognised that the plinth 510 may alternatively be disposed directly on the ground or floor surface.

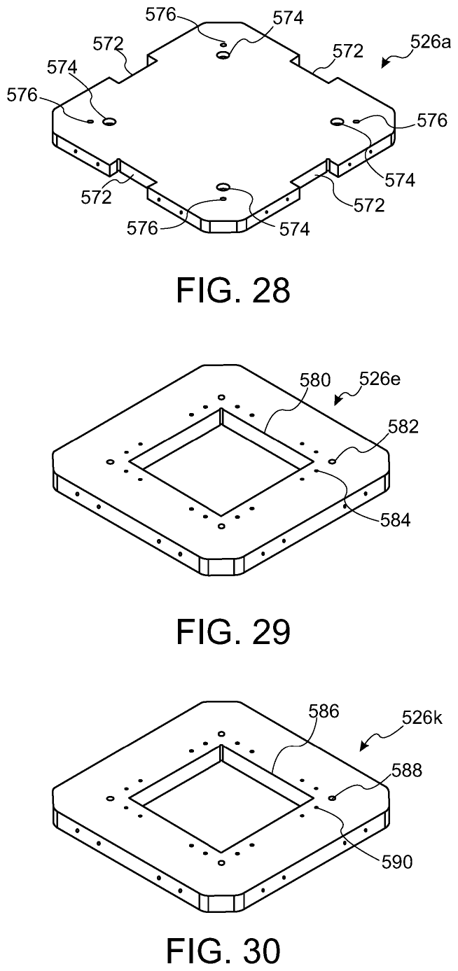

FIG. 28 of the accompanying drawings shows an enlarged perspective view of one of the plates 526a of the cell 510. In the illustrated manufacturing cell 510, the plate 526a is 1 metre long and 1 metre wide. As shown in FIG. 28, the plate 526a has chambered edges at its corners and recesses 572 formed on each side surface.

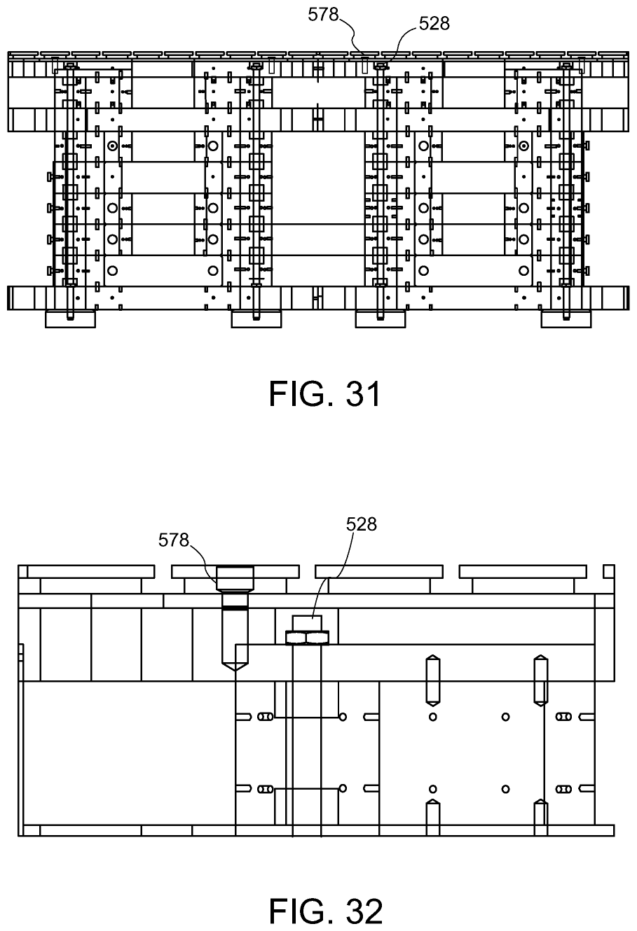

The plate 526a further comprises bores 574 for receiving fasteners 528 (shown in FIGS. 31 and 32) for securing the plate 526a to the blocks 552a, 552b, 552c, 552d, 552e and bores 576 for receiving fasteners 578 for securing the table 514 to the plate 526a.

FIG. 29 shows an enlarged perspective view of one of the plates 526e. In the illustrated manufacturing cell 510, the plate 526e is 1 metre long and 1 metre wide. As shown in FIG. 29, the plate 526e has chambered edges at its corners and has a central opening 580. The plate 526e further comprises bores 582 for receiving the fasteners 528 (shown in FIGS. 31 and 32) and bores 584 for receiving the dowels 360.

FIG. 30 shows an enlarged perspective view of one of the plates 526k. It will be recognised that in the illustrated manufacturing cell 510, the plate 526k is identical in construction to the plate 526e. The plate 526k is 1 metre long and 1 metre wide. As shown in FIG. 30, the plate 526e has chambered edges at its corners and has a central opening 586. The plate 526e further comprises bores 588 for receiving the fasteners 528 (shown in FIGS. 31 and 32) and bores 590 for receiving the dowels 560.

As described above, and referring now also to FIGS. 31 and 32 of the accompanying drawings, the manufacturing cell 510 comprises fasteners 528 for securing the plates 526a, 526e, 526k and blocks 552a, 552b, 552c, 552d, 552e and fasteners 578 for securing the tables 514 to the plates 526a. In the illustrated manufacturing cell 510, the fasteners 528 take the form of threaded rods and the fasteners 578 take the form of bolts.

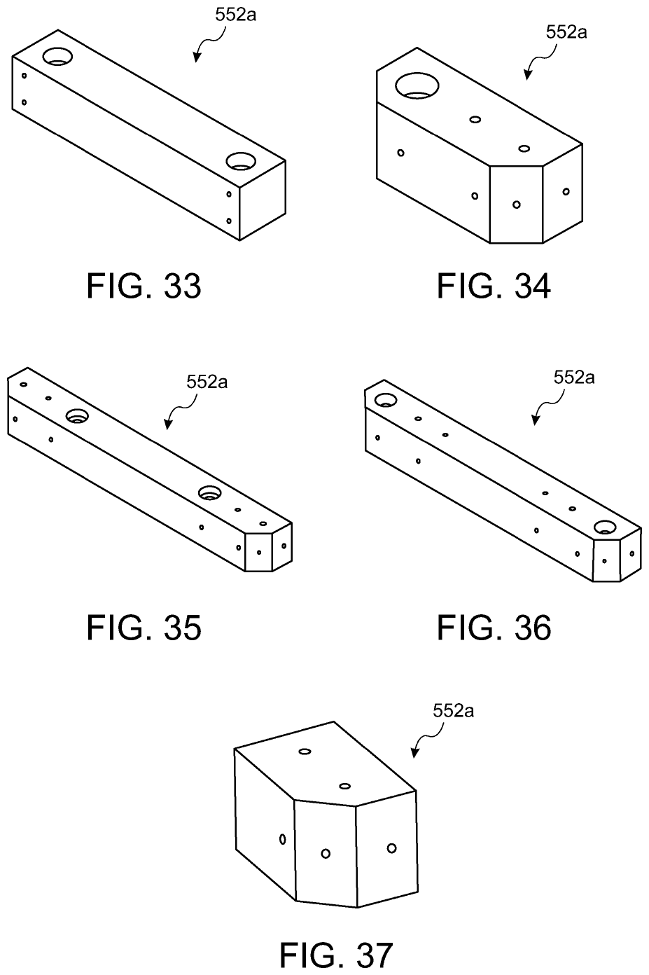

As described above, the plinth 512 is constructed from a plurality of each of the blocks 552a, 552b, 552c, 552d, 552e, and FIGS. 33 to 37 show enlarged perspective views of the blocks 552a, 552b, 552c, 552d, 552e forming the plinth 512.

As described above, it will be understood that various modifications may be made without departing from the scope of the claimed invention.

FIG. 38 of the accompanying drawings shows an alternative manufacturing cell 610.

As shown, the manufacturing cell 610 comprises a plinth 612 and three tables 614, which together form an upper surface of the cell 610.

As in previous embodiments, the plinth 612 is modular and/or reconfigurable in construction and comprises a plurality of the plates 526k, which together form a base of the plinth 612, and a plurality of the blocks 552a, 552b, 552c, 552d, 552e.

The plates 526b (shown in FIGS. 25, 26 and 27) are secured using magnets 592, which as shown in FIG. 38, are embedded in L-shaped brackets 592.

As described above, it will be understood that various modifications may be made without departing from the scope of the claimed invention.

For example, FIG. 39 of the accompanying drawings shows an alternative manufacturing cell 710.

As in previous embodiments, the cell 710 comprises a plinth 712 and a table 714.

The plinth 712 is modular and/or reconfigurable in construction and comprises a plurality of the plates 526k, which together form a base of the plinth 712, and a plurality of the blocks 552a, 552b, 552c, 552d, 552e.

As shown in FIG. 39, in addition to the fasteners 528 the plinth 712 comprises lateral fasteners 794 for providing lateral securement of component of the plinth 712. In the illustrated cell 710, the fasteners take the form of threaded bars similar to the fasteners 528.

It will be recognised that the manufacturing cells of the present disclosure may be adapted to perform a wide variety of functions.

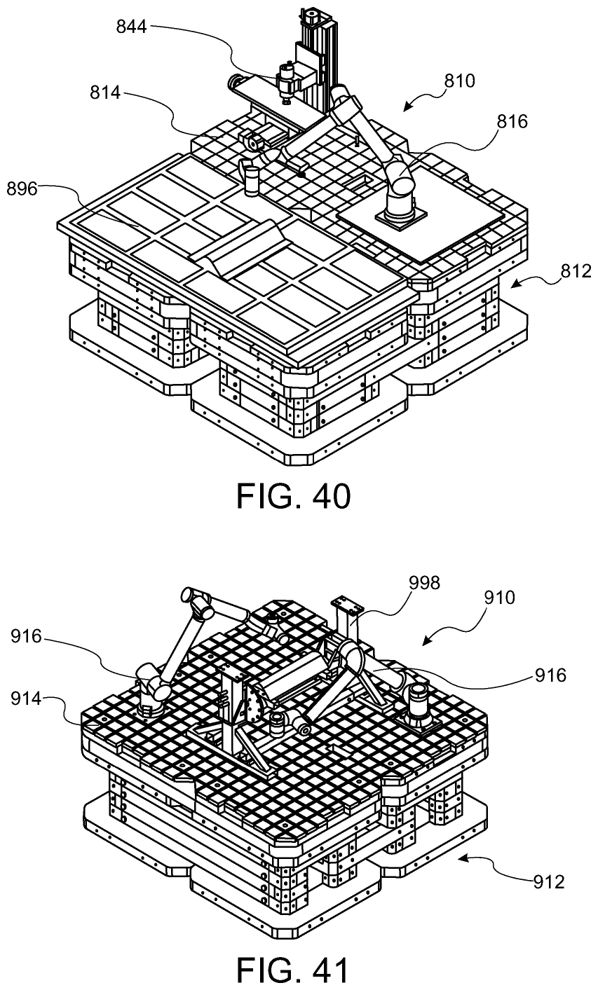

For example, FIG. 40 shows a manufacturing cell 810 comprising a plinth 812 and a table 814. As shown in FIG. 40, the cell 810 further comprises a CNC machine 844, a cobot 816, and a vacuum table 896. The adaptability of the height of the plinth 812 beneficially permits the vacuum table 896 to be disposed flush or substantially flush with the rest of the table 814.

FIG. 41 shows an alternative manufacturing cell 910 comprising a plinth 912 and a table 914. As shown in FIG. 41, the cell 810 further comprises to cobots 916 and a fixture 998 for holding a part P.

As described above, the manufacturing cells may be combined to form a variety of manufacturing systems, e.g. a pilot line or cellular manufacturing system.

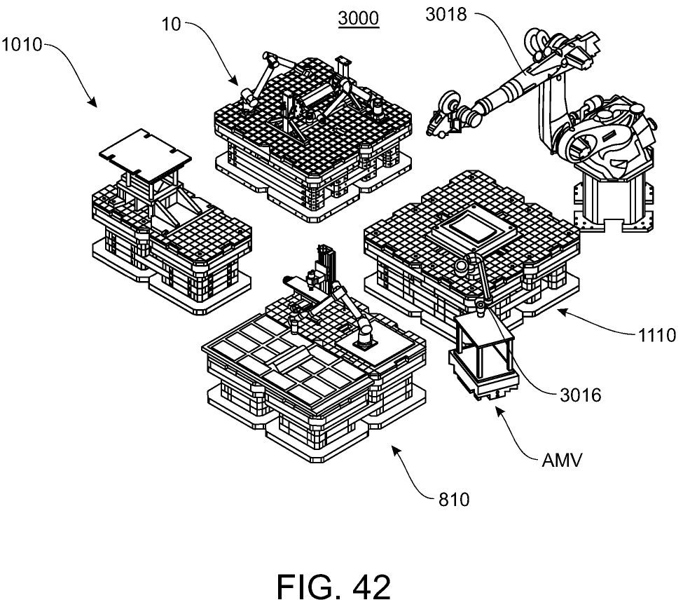

FIG. 42 of the accompanying drawings shows a manufacturing system 3000.

As shown in FIG. 42, the system 3000 comprises cell 810, cell 910. The system 3000 further comprises a forming cell 1010 and a lamination cell 1110. As shown, the system 3000 further comprises an industrial robot 3018 and autonomous vehicle AMV which in the illustrated system 3000 carries a cobot 3016.

1. A manufacturing cell for use in a manufacturing system,
wherein the manufacturing cell is reconfigurable in a plurality of different configurations, the manufacturing cell comprising:
a plinth,
wherein the plinth is modular in construction; and
a table disposed on top of the plinth.

2. The manufacturing cell of claim 1, wherein the plinth comprises a plurality of plates.

3. The manufacturing cell of claim 2, wherein one or more of the plates are constructed from a metal, e.g. Aluminium, or metal alloy.

4. (canceled)

5. The manufacturing cell of claim 2, wherein one or more of the plates are constructed from: a wooden material; a polymeric material; a composite material; and/or a ceramic material.

6. The manufacturing cell of claim 2, wherein:
at least two of the plates are of the same or substantially the same configuration; or
at least one of the plates is of a different configuration to at least one other of the plates.

7. (canceled)

8. The manufacturing cell of claim 1, wherein the plinth comprises a plurality of blocks.

9. The manufacturing cell of claim 8, wherein one or more of the blocks are constructed from a metal, e.g. Aluminium, or metal alloy.

10. (canceled)

11. The manufacturing cell of claim 8, wherein one or more of the blocks are constructed from one or more of: a wooden material; a polymeric material; a composite material; and a ceramic material.

12. The manufacturing cell of claim 8, wherein:
at least two of the blocks are of the same or substantially the same configuration; or
at least one of the blocks is of a different configuration to at least one other of the blocks.

13. (canceled)

14. The manufacturing cell of claim 1, wherein the plinth defines one or more channels.

15. The manufacturing cell of claim 1, wherein the table comprises one or more slots.

16. The manufacturing cell of claim 15, wherein the table comprises one or more T-shaped slots.

17. The manufacturing cell of claim 1, comprising one or more robotic devices.

18. The manufacturing cell of claim 17, wherein one or more of the robotic devices comprises or takes the form of a collaborative robot.

19. The manufacturing cell of claim 17, wherein one or more of the robotic devices comprises or takes the form of an industrial robot.

20. The manufacturing cell of claim 19, wherein the industrial robot is configured to receive an end effector configured to perform an automated fibre placement (AFP) operation.

21. The manufacturing cell of claim 1, comprising a monoblock connector configured to facilitate coupling of the manufacturing cell to one or more services in the form of an electrical supply; a data supply; a hydraulic supply; a pneumatic supply; and/or a water supply.

22. A manufacturing system comprising one or more of the manufacturing cells of claim 1.

23. The manufacturing system of claim 22, wherein the system comprises a plurality of the cells, the system comprising or taking the form of one of:
a manufacturing line; and
a cellular manufacturing system.

24. (canceled)

25. A manufacturing method using one or more of the manufacturing cells according to claim 1 or the manufacturing system according to claim 22.
